(19) United States
(12) Patent Application Publication
(10) Pub. No.: US 2013/0116103 A1
(43) Pub. Date: May 9, 2013

(54) SYSTEMS AND METHODS FOR SEPARATING TARGET MATERIALS IN A SUSPENSION

(71) Applicants: Jonathan Erik Lundt, Seattle, WA (US); Arturo Bernardo Ramirez, Seattle, WA (US)

(72) Inventors: Jonathan Erik Lundt, Seattle, WA (US); Arturo Bernardo Ramirez, Seattle, WA (US)

(21) Appl. No.: 13/444,646

(22) Filed: Apr. 11, 2012

Related U.S. Application Data
(60) Provisional application No. 61/556,885, filed on Nov. 8, 2011.

(51) Int. Cl. B01D 43/00; B04B 7/00

(52) U.S. Cl. 494/37; 422/548

(57) ABSTRACT

Systems and methods that can be used to detect target materials in a suspension are disclosed. A suspension suspected of containing a target material is added to a tube, and a programmable float is added to the same tube. In one aspect, the mass of the float may be programmed by selectively adding one or more objects to the float interior so that when the tube, float and suspension are centrifuged together to separate the various materials of the suspension into layers along the axial length of the tube, the float is positioned at approximately the same level as a layer that contains the target material. The float expands the axial length of the layer between the float outer surface and the inner surface of the tube.

### CROSS-REFERENCE TO RELATED APPLICATION

This application claims the benefit of Provisional Application No. 61/556,885, filed Nov. 8, 2011.

### TECHNICAL FIELD

This disclosure relates generally to density-based fluid separation and, in particular, to tube and float systems for the separation and axial expansion of constituent suspension components layered by centrifugation.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as ova, fetal cells, endothelial cells, parasites, bacteria, and inflammatory cells, and viruses, including HIV, cytomegalovirus, hepatitis C virus, and Epstein-Barr virus. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 5 CTCs is considered clinically relevant in the diagnosis and treatment of a cancer patient. However, detecting even 1 CTC in a 7.5 ml blood sample is equivalent to detecting 1 CTC in a background of about 50 billion red and white blood cells. Using existing techniques to find as few as 5 CTCs in a whole blood sample is extremely time consuming, costly and difficult to accomplish. As a result, practitioners, researchers, and those working with suspensions continue to seek systems and methods to more efficiently and accurately analyze suspensions for the presence of materials of interest.

### SUMMARY

Systems and methods that can be used to detect target materials in a suspension are disclosed. A suspension suspected of containing a target material is added to a tube, and a programmable float is added to the same tube. In one aspect, the mass of the float may be programmed by selectively adding one or more objects to the float interior so that when the tube, float and suspension are centrifuged together to separate the various materials of the suspension into layers along the axial length of the tube, the float is positioned at approximately the same level as a layer that contains the target material. In another aspect, the volume of the float may be programmed by selectively altering an exterior volume of the float so that when the tube, float and suspension are centrifuged together to separate the various materials of the suspension into layers along the axial length of the tube, the float is positioned at approximately the same level as a layer that contains the target material. The float expands the axial length of the layer between the float outer surface and the inner surface of the tube.

### DESCRIPTION OF THE DRAWINGS

FIGS. 1A-1B show isometric views of two example tube and float systems.

FIGS. 2A-2C show isometric, exploded and cross-sectional views, respectively, of an example programmable float.

FIGS. 3A-3B show exploded isometric and cross-sectional views, respectively, of an example programmable float.

FIGS. 4A-4B show exploded isometric and cross-sectional views, respectively, of an example programmable float.

FIGS. 5A-5B show exploded isometric and cross-sectional views, respectively, of an example programmable float.

FIGS. 6A-6D show four examples of different types of floats.

FIGS. 7A-7D show cross-sectional views of four example floats, each with a different arrangement of objects.

FIG. 8 shows a cross-sectional view of a programmable float disposed within a tube of a tube and float system.

FIGS. 9A-9C show examples of a tube and float system with magnets used to position or extract a programmable float.

FIG. 10 shows a cross-sectional view of an example tube and float system with a magnet used to position or extract a programmable float.

FIGS. 11A-11B show cross-sectional views of an example tube and float system with a rod used to position or extract a programmable float.

FIGS. 12A-12B show cross-sectional views of an example tube and float system with a needle used to position or extract a programmable float.

### DETAILED DESCRIPTION

The detailed description is organized into three subsections: (1) A description of tube and float systems is provided in a first subsection. (2) A description of programmable floats is provided in a second subsection. (3) A description of systems and methods for positioning and extracting a programmable float from a tube is provided in a third subsection.

### Tube and Float Systems

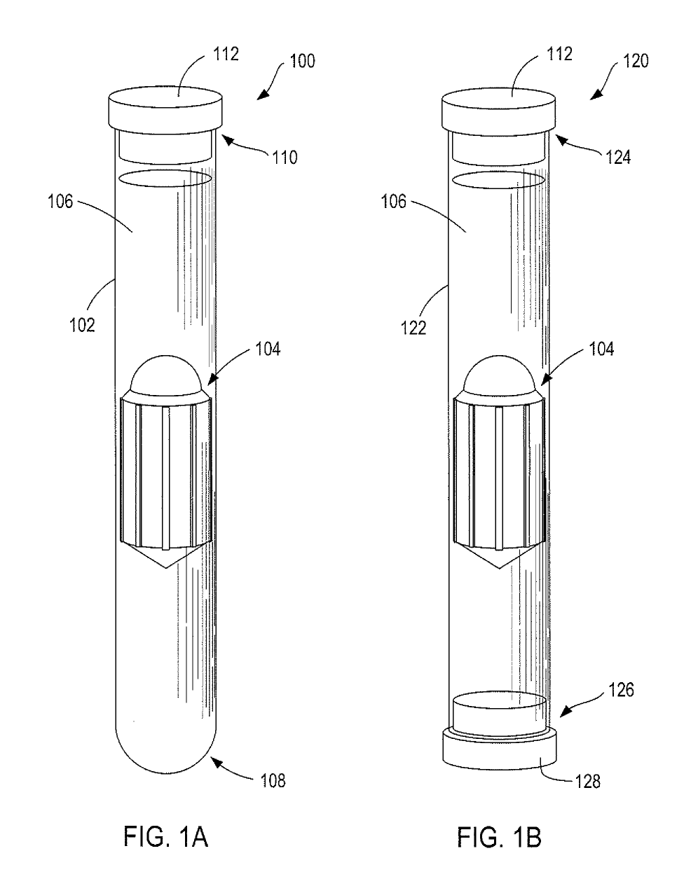

FIG. 1A shows an isometric view of an example tube and float system 100. The system 100 includes a tube 102 and a programmable float 104 suspended within a suspension 106. In the example of FIG. 1A, the tube 102 has a circular cross-section, a first closed end 108, and a second open end 110. The open end 110 is sized to receive a stopper or cap 112. A tube may also have two open ends that are sized to receive stoppers or caps, such as the tube 122 of example tube and float system 120 shown FIG. 1B. The system 120 is similar to the system 100 except the tube 102 of the system 102 is replaced by a tube 122 that includes two open ends 124 and 126 configured to receive the cap 112 and a cap 128, respectively. The tubes 102 and 122 have a generally cylindrical geometry, but may also have a tapered geometry that widens toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as flexible plastic or another suitable material.

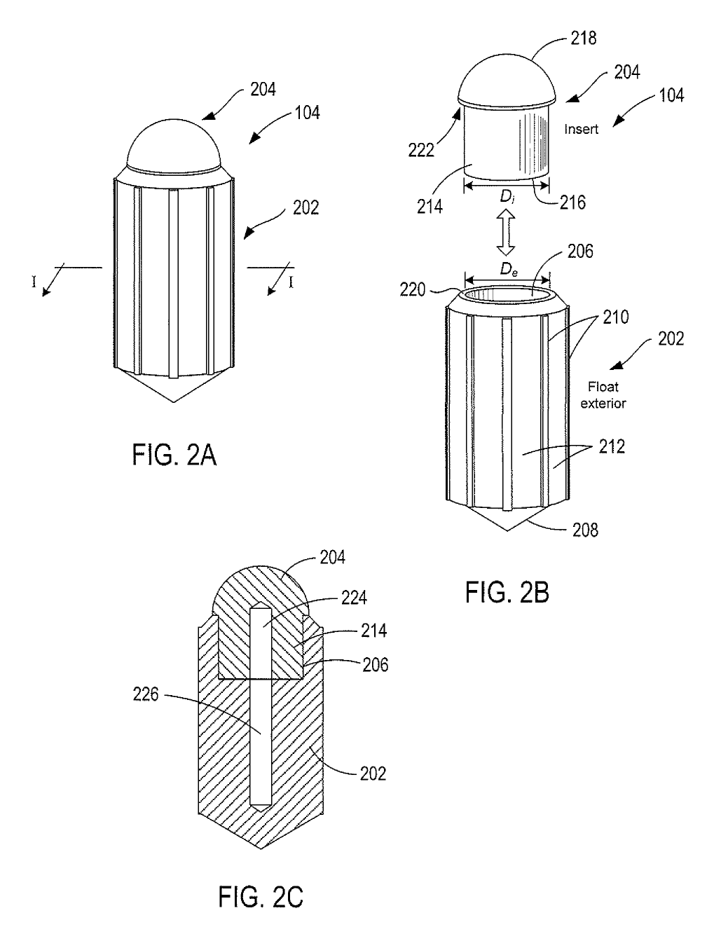

FIGS. 2A-2C show isometric, exploded and cross-sectional views, respectively, of the programmable float 104. The float 104 includes a float exterior 202 and an insert 204. FIG. 2B reveals that the float exterior 202 includes a cylindrical-shaped opening 206, a closed, cone-shaped tapered end 208, and splines 210 that span the height of the main body 212. The splines 210 may be separately formed and attached to the main body 212, or the splines 210 and the main body 212 can form a single structure. The splines 210 create channels along which a fluid and particles can flow between the main body 212 and the inner wall of the tube 102. The number of splines, spline radial spacing, and spline width and thickness can be varied to create channels of desired depth and radial width. FIG. 2B also reveals that the insert 204 has a cylindrical-shaped plug or stopper 214 with an end 216 and a dome-shaped head 218. The float exterior 202 includes a ledge 220 that forms a seal with a flat annular-shaped surface 222 surrounding the base of plug 214. The diameter of the plug 214 is denoted by Dᵢ and the diameter of the opening 206 is denoted by Dₑ. In certain embodiments, the plug 214 can have a slightly larger diameter than the opening 206 (i.e., Dᵢ>Dₑ) creating a negative clearance. As a result, the plug 214 is pressed into the opening 206 where frictional forces between the inner wall of the opening 206 and outer surface of the plug 214 hold the insert 204 in place. In another embodiment, the plug 214 can have approximately the same diameter as the opening 206 (i.e., Dᵢ≈Dₑ) creating a zero clearance when the plug 214 is inserted into the opening 206. Frictional forces between the inner wall of the opening 206 and outer surface of the plug 214 may also be a factor in holding the insert 204 in place. In another embodiment, the diameter of the plug 214 can be less than the diameter of the opening 206 (i.e., Dᵢ<Dₑ) creating a positive clearance when the plug 214 is inserted into the opening 206. When the plug 214 is fully inserted into the opening 206, as shown in FIG. 2A, the surface 222 engages the ledge 220 to form an air-tight and fluid-tight seal. In certain embodiments, an air-tight and fluid-tight seal can be created by applying an adhesive or epoxy between the surface 222 and the ledge 220. The adhesive fastens the plug 214 to the float exterior 202. In other embodiments, the plug 214 and the float exterior 202 can be sealed by welding an annular seam between the surface 222 and the ledge 220. For example, the plug 214 and the float exterior 202 can be welded together along the seam using ultrasonic welding or laser welding. FIG. 2C shows a cross-sectional view along a line shown in FIG. 2A, of the insert 204 fully inserted into the opening 206 of the float exterior 202. As shown in FIG. 2C, the plug 214 is dimensioned to fill the opening 206. FIG. 2C also reveals that the insert 204 includes a first opening 224 and the float exterior 206 includes a second opening 226. When the insert 204 is fully inserted into the float exterior 202, the openings 224 and 226 are substantially aligned to form an enclosed, air-tight cavity directed along the central or highest-symmetry axis of the float 104.

The float exterior 202 and the insert 204 can be composed of the same materials or be composed of different materials. The material used to form the float exterior 202 and the insert 204 include, but are not limited to, rigid organic or inorganic materials, and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (“PPO”), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer (“ABS”) and others.

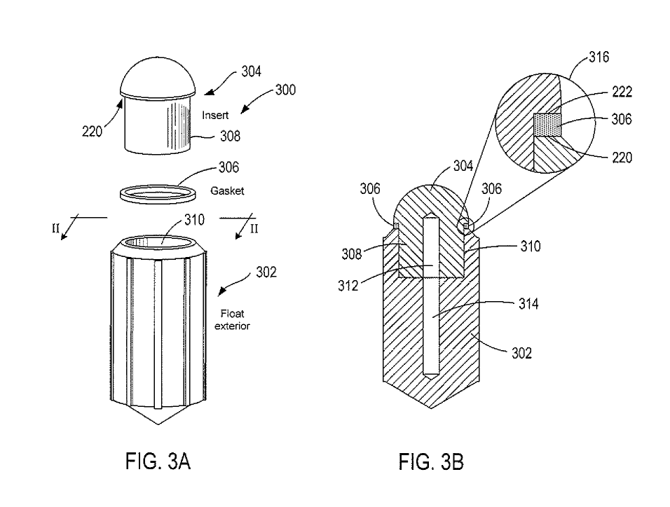

In other embodiments, the float can include a gasket to seal the annular seam between the insert and the float exterior. FIG. 3A shows an exploded isometric view of an example programmable float 300. The float 300 includes a float exterior 302, an insert 304, and a gasket 306. The float exterior 302 is similar to the float exterior 202. The insert plug 308 may include an annular-shaped groove located near the surface 220 into which the gasket 306 can be inserted. FIG. 3B shows a cross-sectional view along a line shown in FIG. 3A, of the insert 304 fully inserted into an opening 310 of the float exterior 302 with a first opening 312 aligned with a second opening 314. FIG. 3B includes an enlargement 316 of the gasket 306 compressed between the surface 222 of the insert 304 and the ledge 220 of the float exterior 302 forming an air-tight and fluid-tight seal. Note that an adhesive may also be used to attach the gasket 306 to the surface 222 and the ledge 220.

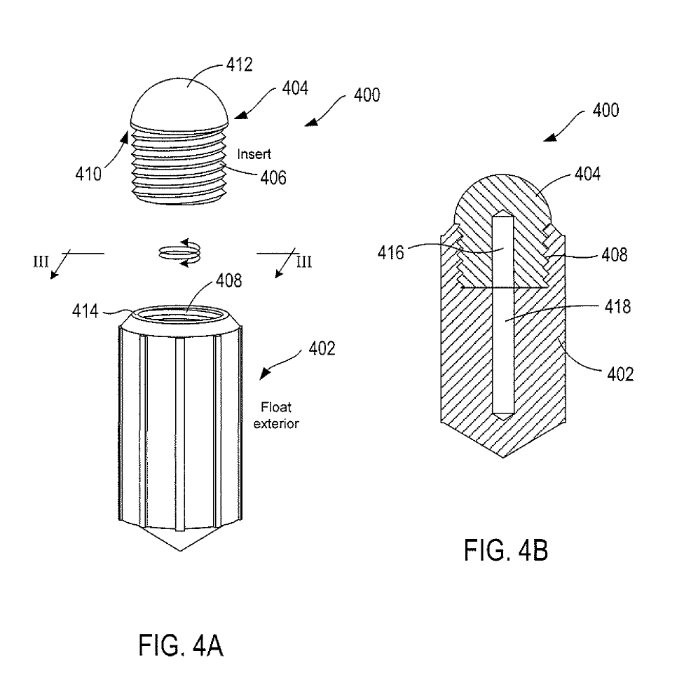

In other embodiments, the plug of the insert and the opening of the float exterior can be threaded. FIG. 4A shows an isometric view of an example screw-fit programmable float 400. The float 400 includes a float exterior 402 and an insert 404. As shown in FIG. 4A, the outer surface of the insert plug 406 and inner wall of an opening 408 formed in the float exterior 402 have matching helical threads. The plug 406 portion of the insert 404 can be screwed into the opening 408. When the insert 404 is fully screwed into the opening 408, annular surface 410 of head 412 engages a ledge 414 of the float exterior 402 to form an air-tight and a fluid-tight seal. FIG. 4B shows a cross-sectional view along a line shown in FIG. 4A, of the insert 404 screwed into the opening 408 of the float exterior 402. The threaded plug 406 and threaded opening 408 are an alternative to the press-fit floats described above, because the interlocking helical threads of the plug 406 and opening 408 may also provide a substantially air-tight and fluid-tight seal of the cavity formed by a first opening 416 in the insert 404 and a second opening 418 in the exterior 402.

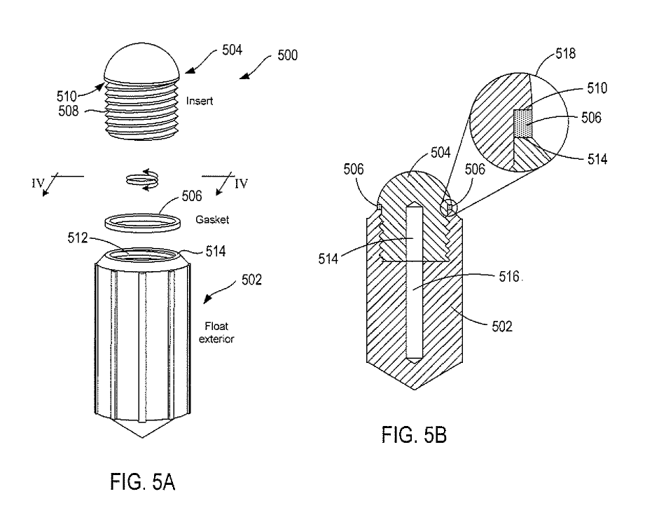

FIG. 5A shows an isometric view of an example screw-fit programmable float 500. The float 500 includes a float exterior 502, an insert 504, and a gasket 506. The insert plug 508 may include an annular-shaped groove located near the surface 510 into which the gasket 506 can be inserted. FIG. 5B shows a cross-sectional view along a line IV-IV, shown in FIG. 5A, of the insert 504 fully screwed into an opening 512 of the float exterior 502 with a first opening 514 aligned with a second opening 516. FIG. 5B includes an enlargement 518 of the gasket 506 compressed between the surface 510 of the insert 504 and the ledge 514 of the float exterior 502 fixating an air-tight and fluid-tight seal. Note that an adhesive may also be used to attach the gasket 506 to the surface 510 and the ledge 514.

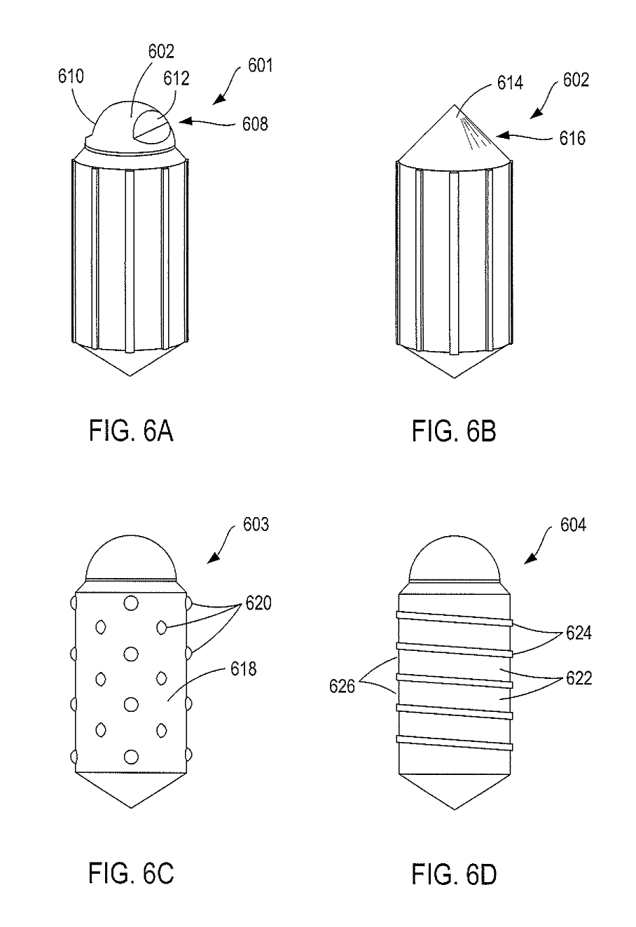

Embodiments include other types of geometric shapes for float end caps. FIGS. 6A-6D show four examples of different types of programmable floats 601-604. In FIG. 6A, the float 601 is similar to the floats described above except the head 606 of the insert 608 includes finger grips 610 and 612. In FIG. 6B, the head 614 of the insert 616 of the float 602 is cone shaped. The float exterior of float can also have a dome-shaped end cap. The insert and float exterior end caps can have other geometric shapes and are not intended to be limited the shapes described herein. In other embodiments, the main body of a float can include a variety of different structural elements for separating target materials, supporting the tube wall, or directing the suspension fluid around the float during centrifugation. FIGS. 6C and 6D show two examples of different main body structural elements. In FIG. 6C, the main body 618 of the float 603 includes a number of protrusions 620 that provide support for the deformable tube. In other embodiments, the number, size and pattern of protrusions can be varied. In FIG. 6D, the main body 622 of the float 604 includes a single continuous helical structure or ridge 624 that spirals around the main body 622 creating a helical channel 626. Float embodiments are not intended to be limited to these two examples. In other embodiments, the helical ridge 624 can be rounded or broken or segmented to allow fluid to flow between adjacent turns of the helical ridge 624. In various embodiments, the helical ridge spacing and rib thickness can be independently varied.

### Programmable Floats

### 1. Programmable by Mass

The floats described above can be programmed with a desired mass in order to position the float within the tube to trap target materials with a particular density between the main body of the float and the inner wall of the tube. A programmable float is programmed by selectively adding one or more objects to the float interior, which changes the mass of the float. An object can have any shape including, but are not limited to, a sphere, a ring, a cube, a cylinder, and an irregular shape. An object can be composed of, but is not limited to, a metal, a ceramic, a plastic, or a magnetic material. For example, the objects can be a spherical and composed of polystyrene. Note that in addition to adding objects to a float interior, a desired mass for the float can also be obtained by an appropriate selection of the float exterior and the insert materials.

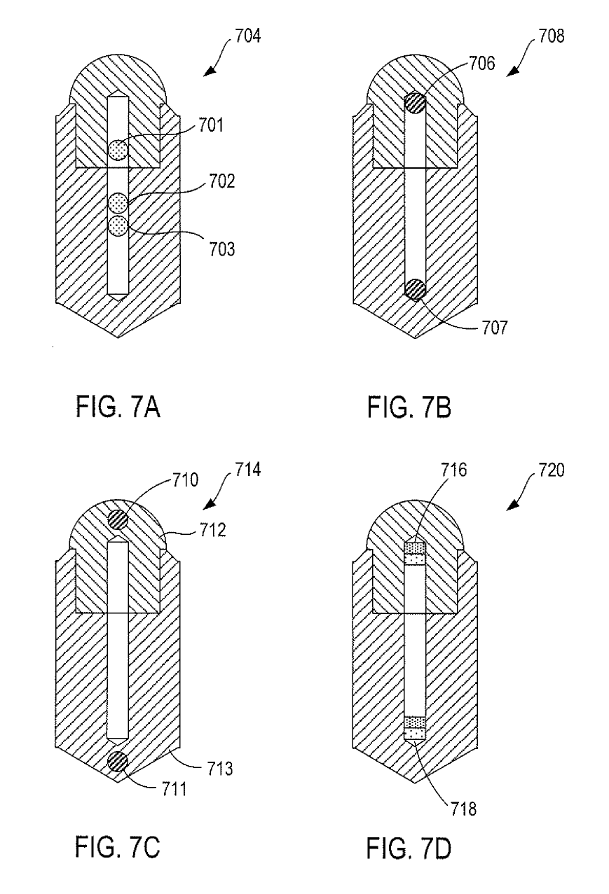

FIGS. 7A-7D show cross-sectional views of four example floats, each with a different arrangement of objects along the central or highest-symmetry axis of the float. In FIG. 7A, the objects are three beads 701-703 placed within a cavity of a float 704. The beads 701-703 can be composed of the same material, such as polystyrene or a suitable metal, or the beads 701-703 can each be composed of any combination of different materials selected to give the float 704 a desired mass. The beads 701-703 can be press fit into the cavity or held in place with an adhesive. In FIG. 7B, the objects are two objects 706 and 707 placed at opposites ends of a cavity within a float 708. The beads 706 and 707 can be press fit into the ends of the cavity or held in place with an adhesive. In FIG. 7C, the objects are two beads 710 and 711 embedded within an insert 712 and a float exterior 713, respectively, of a float 714. The float 714 can also include one or more objects (not shown) placed with the float cavity. In FIG. 7D, the objects are two magnets 716 and 718 placed at opposite ends of a cavity within a float 720. In the example of FIG. 7, the magnets 716 and 718 are permanent magnets positioned within the cavity so that the magnetic moments point in the same direction along the central axis of the float 720. In particular, dark shaded regions of the magnets 716 and 718 represent the north poles and lighter shaded regions represent the south poles. Note that the terms “north” and “south” are merely used to distinguish to the two different ends of the magnets. By convention, the magnetic field lines of a magnet emerge from the north pole and reenter the magnet at the south pole. In other embodiments, the magnets can be placed so that the magnetic moments point in opposite directions or point in any desired direction and other objects can also be added to the float cavity. Float embodiments are not intended to be limited to the examples of objects shown in FIGS. 7A-7D. In other embodiments, a programmable float can be configured with any combination of embedded objects, objects inserted into the float cavity, or magnets.

The density of the programmable float changes proportionally with respect to the mass of the one or more objects added to the float interior and can be calculated by:

$${ρ}_{float} \approx \frac{{m}_{ext} + {m}_{in} + {m}_{air} + {m}_{obj}}{{v}_{ext} + {v}_{in} + {v}_{cav}}$$

where mₑₓₜ is the mass of the float exterior;
mᵢₙ is the mass of the insert;
mₐᵢᵣ is mass of the air trapped in the cavity;
m_{obj} is the total mass of the one or more objects;
vₑₓₜ is volume of the float exterior;
vᵢₙ is the volume of the float insert; and
v_{cav} is the volume of the cavity.

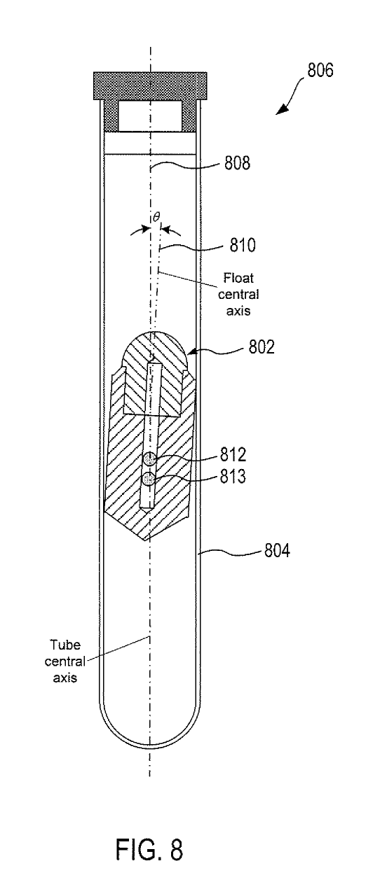

The tube and float each have a central or highest-symmetry axis and when the float is inserted into the tube, the central axis of the tube and the central axis of the float are nearly collinear. Alternatively, the programmable float enables the objects to be inserted to change the float's distribution of mass, which results in the central axis of the float no longer being collinear with the central axis of the tube. In other words, the float can be programmed to tilt so that during centrifugation the central axis of the float is at a non-zero angle, θ, with respect to the central axis of the tube. FIG. 8 shows a cross-sectional view of a programmable float 802 disposed within a tube 804 of a tube and float system 806. Dot-dash line 808 represents the central axis of the tube 804, and double-dot-dash line 810 represents the central axis of the float 802. In the example of FIG. 8, the float 802 includes two objects 812 and 813 placed within the float cavity so that the central axis 810 of the float 802 is tilted through an angle θ with respect to the central axis 808 of the tube 804. Ideally, the angle θ ranges anywhere from between 0° to about 6°. When the central axis of the float is allowed to tilt away from the central axis of tube during centrifugation, the fluid and material components of a suspension are distributed differently than when the central axis of the float is substantially aligned with the central axis of the tube. As a result, the different layers of material may be more easily distinguished and allowing the float to tilt may decrease fluid and material reflux.

### 2. Programmable by Volume

The floats described above can be programmed with a desired volume in order to position the float within the tube to trap target materials with a particular density between the main body of the float and the inner wall of the tube. A programmable float is programmed by selectively altering an exterior volume of the float, which changes the mass of the float.

As discussed above, FIGS. 4A and 4B show an isometric view of an example screw-fit programmable float 400 and a cross-sectional view along a line shown in FIG. 4A, of the insert 404 screwed into the opening 408 of the float exterior 402, respectively. The plug 406 portion of the insert 404 can be screwed into the opening 408. The insert 404 may be screwed into the opening 408, whereby the annular surface 410 of head 412 engages a ledge 414 of the float exterior 402 to form an air-tight and a fluid-tight seal. To alter the exterior volume of the programmable float 400, the torque applied to the insert 404 may be increased, which causes the exterior volume of the head 412 to decrease, which, in turn, increases the volume of the plug 406 within the float exterior 402. The change in the length of the plug 406 and subsequently the change in the volume of the programmable float 400 is exponentially related to the torque applied to the insert 404. The change in volume of the float exterior 402 is negligible, when any change occurs to in length of the plug 406 and the exterior volume of the head 412. Because the exterior volume of the head 412 decreases and the exterior volume of the float exterior 402 essentially remains constant, the density of the float 400 increases. Releasing or decreasing the torque (i.e., by unscrewing the insert 404) decreases the exterior volume of the head 412, thereby decreasing the density.

### Methods and Systems for Positioning and Extracting a Programmable Float from a Tube

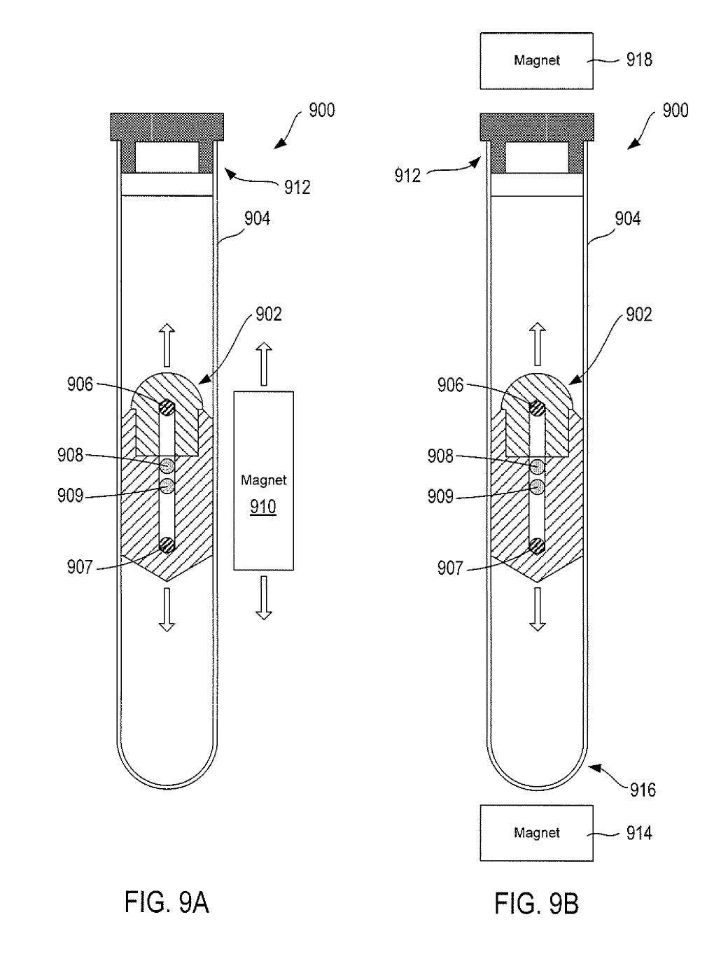

The objects selected for placement in a programmable float interior can be selected to give the float a desired density, as described above, and the objects can also be selected so that the float can be moved to a desired position along the central axis of the tube or removed from the tube. FIGS. 9A-9C show examples of a tube and float system 900 configured so that a magnetic field can be used to change the position of a programmable float 902 in a tube 904. The float 902 includes two metal objects 906 and 907 located at opposite ends of the float cavity and includes two objects 908 and 909 located near the center of the cavity. The masses of the objects 906-909 can be selected to give the float 902 a desired density as described above, but the metal objects 906 and 907 also enable the float 902 to be repositioned along the tube 904 or removed altogether. In FIG. 9A, the magnetic field generated by a magnet 910 placed near the tube 904 interacts with the metal objects 906 and 907 such that when the magnet is moved substantially parallel to the central axis of the tube 904, the float 902 moves in the same direction. The magnet 910 can be used to change the axial position of the float 902 or move the float 902 to the opening 912 so that the float 902 can be extracted. In FIG. 9B, a magnet 914 can be placed near the closed end 916 of the tube 904 to draw the float 902 toward the closed end 916, or a magnet 918 can be placed near the open end 912 to draw the float 902 to the open end 912. In FIG. 9C, an electromagnet including a coiled wire 920 and tunable current source (not shown) can be used to control the position of the float 902 or move the float 902 to the open end 912 so that the float 902 can be extracted. In the example of FIG. 9C, the tube 904 is located along the central axis of the coiled wire 920. The strength of the magnetic field applied to the float 902 can be controlled by applying an appropriate current to the coiled wire 920. The float 902 can be repositioned or removed from the tube 904 by sliding the tube 904, sliding the coiled wire 920, or by moving the tube 904 and the coiled wire 920 in opposite directions. Alternatively, the tube 904 can be located outside the coiled wire 920 and used in the same manner as the permanent magnet 910.

Note that the permanent magnet 910 and the electromagnet can also be used to maintain the position of the float 902 rather than move the float 902. For example, when the tube and float system 900 is centrifuged the magnet 910 can be attached to or near the side of the tube 904 to prevent the float 902 from moving during centrifugation.

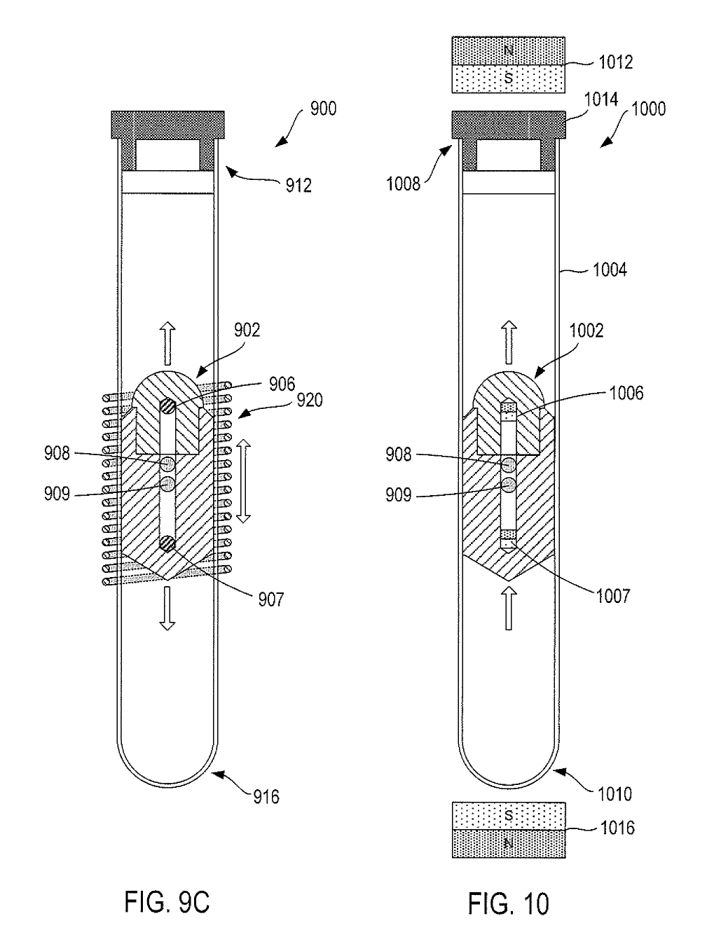

FIG. 10 shows a cross-sectional view of an example tube and float system 1000. The system 1000 is similar to the system 900 except the system 1000 includes a programmable float 1002 with permanent magnets 1006 and 1007 in place of the metal objects 906 and 907 of the float 902 and the objects 908 and 909 are non-metal objects. In the example of FIG. 10, the magnets 1006 and 1007 are positioned as described above with reference to FIG. 7D. The float 1002 can be moved along the length of the tube 1004 using repulsive or attractive magnetic forces created by placing a magnetic along the central axis of the tube 1004. For example, as shown in FIG. 7D, when a magnet 1012 is placed near a cap 1014 inserted into the open end 1008 so that the south pole of the magnetic 1012 faces the north pole of the magnets 1006 and 1007, an attractive magnetic force is created that draws the float 1002 toward the open end 1008. When a magnet 1016 is placed so that the south pole of the magnetic 1016 faces the south pole of the magnets 1006 and 1007, a repulsive magnetic force is created that pushes the float 1002 toward the open end 1008.

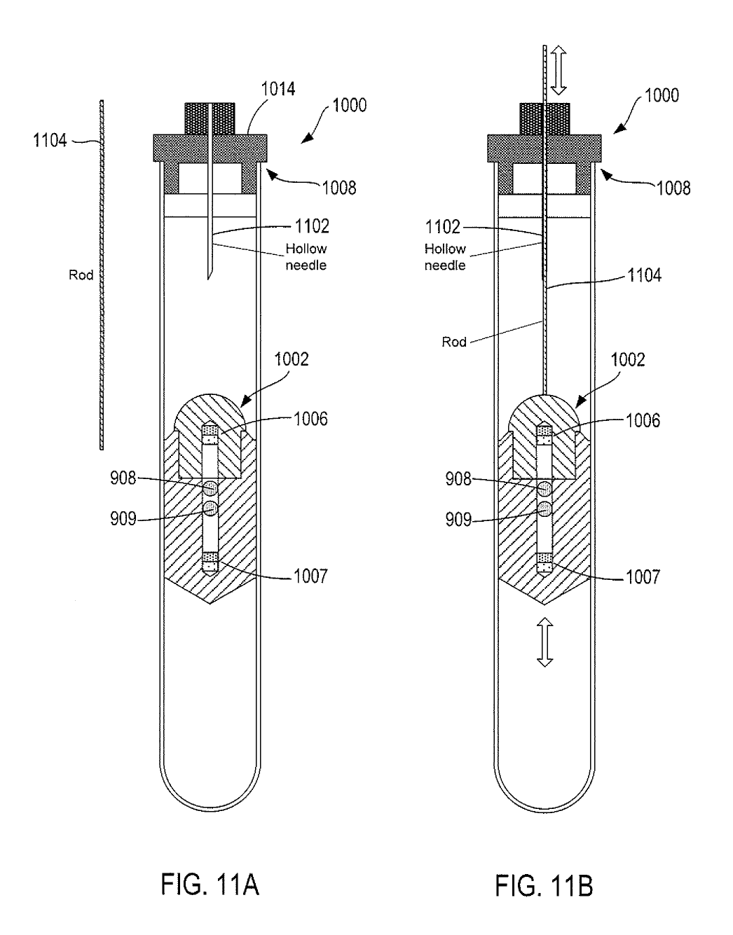

In other embodiments, a metal rod can be used to change the position of the float 1002 or to extract the float 1002 through the open end 1008. FIGS. 11A-11B show cross-sectional views of the tube and float system 1000. In FIG. 11A, a hollow needle 1102 is inserted through the cap 1014. A metal rod 1104 having a diameter smaller than the bore diameter of the hollow needle 1102 is used to move and/or extract the float 1002. In FIG. 11B, the rod 1104 is inserted into the tube 1004 through the needle 1102 so that the end of the rod 1104 is in contact with the float 1002. The magnetic force created by the magnet 1006 holds the float 1002 against the end of the rod 1104 so that as the rod 1104 is moved up and down within the hollow needle 1102, the float 1002 moves with the rod 1104. The attractive magnetic force may be strong enough to enable the float 1002 to be extracted from the open end 1008 of the tube 1004.

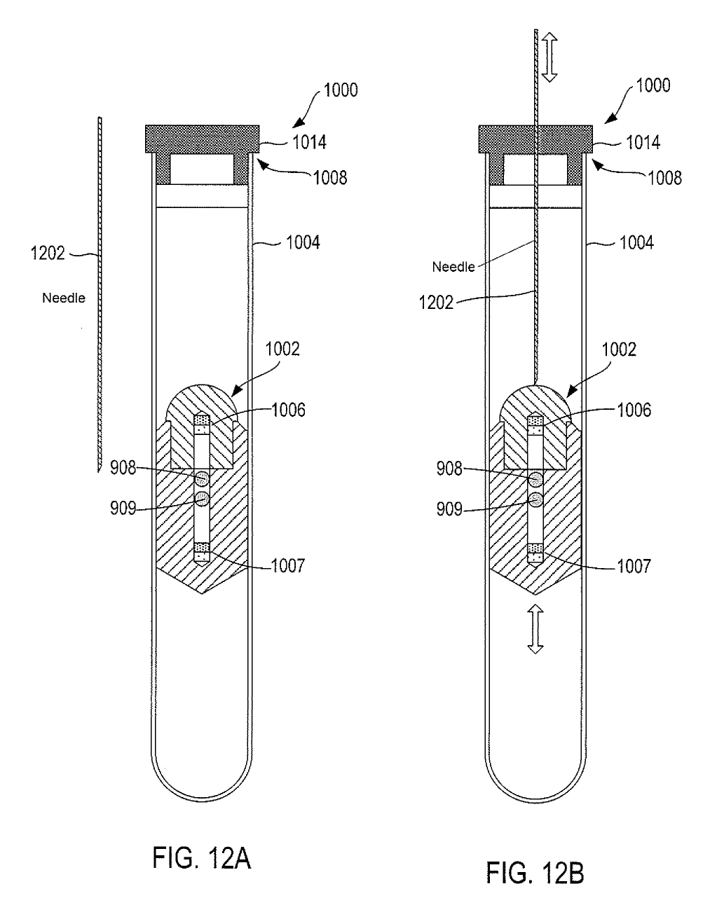

In other embodiments, a metal needle can be used to change the position of the float 1002 or to extract the float 1002 through the open end 1008. FIGS. 12A-12B show cross-sectional views of the tube and float system 1000. FIG. 12A shows a needle 1202 to be inserted through the cap 1014. In FIG. 12B, the needle 1202 is inserted into the tube 1004 through the cap 1014 so that the end of the needle 1202 is in contact with the float 1002. The magnetic force created by the magnets 1006 and 1007 holds the float 1002 against the end of the needle 1202 so that as the needle 1202 is moved up and down, the float 1002 moves with the needle 1202. The attractive magnetic force may be strong enough to enable the float 1002 to be extracted from the open end 1008 of the tube 1004.

The foregoing description, for purposes of explanation, used specific nomenclature to provide a thorough understanding of the disclosure. However, it will be apparent to one skilled in the art that the specific details are not required in order to practice the systems and methods described herein. For example, methods and systems described above are not intended to be limited to used of the tube and float system 100 represented in FIG. 1A. Method embodiments can be carried in the same manner using the tube and float system 120 shown in FIG. 1B. The foregoing descriptions of specific embodiments are presented by way of examples for purposes of illustration and description. They are not intended to be exhaustive of or to limit this disclosure to the precise forms described. Obviously, many modifications and variations are possible in view of the above teachings. For example, programmable float embodiments are not intended to be limited to the example programmable float 902, which has two metal objects, and the example programmable float 1002 which has two magnets. In practice, a programmable float to be moved or extracted from a tube using the methods and systems described above can be configured with any number of metal objects or any number of magnets or any combination of objects and magnets. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A system for separating a target material of a suspension, the system comprising:
a tube to receive the suspension; and
a programmable float to be inserted in the tube, wherein the float includes an insert with a first opening and a float exterior with a second opening such that when the insert is inserted into the float exterior, the first and second openings are substantially aligned to form a cavity within the float.

2. The system of claim 1, wherein the float includes one or more objects located internally.

3. The system of claim 2, wherein the one or more objects include a shape selected from a sphere, a ring, a cube, a cylinder, and an irregular shape.

4. The system of claim 2, wherein the one or more objects include a material selected from a metal, a ceramic, a plastic, and a permanent magnet material.

5. The system of claim 4, wherein the one or more objects are polystyrene beads.

6. The system of claim 2, wherein the one or more objects are located in the cavity.

7. The system of claim 2, wherein the one or more objects are embedded in the insert and the float exterior.

8. The system of claim 1, wherein the cavity is directed along the central axis of the float.

9. The system of claim 1, wherein a central axis of the float is at a non-zero angle with respect to a central axis of the tube.

10. The system of claim 1, wherein the non-zero angle is less than about 6 degrees.

11. A system for separating a target material of a suspension, the system comprising:
a tube to receive the suspension;
a float to be inserted in the tube, wherein the float includes one or more objects located internally; and
a moving device to move the float within the tube with use of a magnetic force created between at least one of the one or more objects and the moving device.

12. The system of claim 11, wherein the at least one object further comprises a metal object and the moving device further comprises a magnet.

13. The system of claim 12, wherein the magnet is an electromagnet.

14. The system of claim 11, wherein the at least one object further comprises a magnet and the moving device further comprises a hollow needle and a metal rod, the hollow needle to be inserted into the tube and the rod to be inserted in the hollow needle, wherein the magnetic force is to attach the rod to the float.

15. The system of claim 14, wherein the at least one object further comprises a magnet and the moving device further comprises a needle to be inserted into the tube, wherein the magnetic force is to attach the rod to the float.

16. The system of claim 14, wherein the at least one object further comprises a magnet and the moving device further comprises a magnet.

17. A method for moving a float of a tube and float system, the method comprising:
inserting a float into a tube containing a fluid;
centrifuging the float, tube and fluid together; and
applying a magnetic force to position the float within the tube using a moving device.

18. The method of claim 17, wherein the float includes one or more metal objects and the moving device further comprises a magnet.

19. The method of claim 18, wherein the magnet is an electromagnet.

20. The method of claim 17, wherein the float further comprises one or more magnetic objects and the moving device further comprises a hollow needle and a rod, the hollow needle inserted into the tube and the rod inserted into the hollow needle, wherein the magnetic force attaches the rod to the float.

21. The method of claim 20, wherein the float further comprises one or more magnetic objects and the moving device further comprises a needle inserted in the tube, wherein when the needle is inserted into the tube, the magnetic force attaches the rod to the float.

22. The method of claim 20, wherein the float object further comprises one or more magnets and the moving device further comprises a magnet.
